(19) United States
(12) Patent Application Publication
(10) Pub. No.: US 2013/0290606 A1
(43) Pub. Date: Oct. 31, 2013

(54) POWER MANAGEMENT FOR A SYSTEM HAVING NON-VOLATILE MEMORY

(71) Applicants: Victor E. Alessi, Scotts Valley, CA (US); Nicholas C. Seroff, Los Gatos, CA (US); Arjun Kapoor, San Francisco, CA (US); Nir Jacob Wakrat, Los Altos, CA (US); Anthony Fai, Palo Alto, CA (US)

(72) Inventors: Victor E. Alessi, Scotts Valley, CA (US); Nicholas C. Seroff, Los Gatos, CA (US); Arjun Kapoor, San Francisco, CA (US); Nir Jacob Wakrat, Los Altos, CA (US); Anthony Fai, Palo Alto, CA (US)

(73) Assignee: Apple Inc., Cupertino, CA (US)

(21) Appl. No.: 13/459,878

(22) Filed: Apr. 30, 2012

(51) Int. Cl. G06F 12/00

(52) U.S. Cl. 711/103; 711/E12.008

(57) ABSTRACT

Systems and methods are disclosed for power management of a system having non-volatile memory (“NVM”). One or more controllers of the system can optimally turn modules on or off and/or intelligently adjust the operating speeds of modules and interfaces of the system based on the type of incoming commands and the current conditions of the system. This can result in optimal system performance and reduced system power consumption.

### BACKGROUND OF THE DISCLOSURE

NAND flash memory, as well as other types of non-volatile memories (“NVMs”), are commonly used for mass storage. For example, consumer electronics such as portable media players often include flash memory to store music, videos, and other media.

A system having a non-volatile memory can include one or more controllers to perform access commands (e.g., program, read, and erase commands) and memory management functions on the NVM. Because components of such a system may be kept continuously awake and may operate at pre-configured operating speeds, power consumption in the system can be negatively impacted.

### SUMMARY OF THE DISCLOSURE

Systems and methods are disclosed for power management of a system having non-volatile memory (“NVM”). One or more controllers of the system can intelligently turn modules on or off and/or adjust the operating speeds of modules and interfaces of the system based on the type of incoming commands and the current conditions of the system. This can result in optimal system performance and reduced system power consumption.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 is a block diagram of an electronic device configured in accordance with various embodiments of the invention;

FIG. 2 is a flowchart of an illustrative process for adjusting operating speeds of one or more modules and interfaces in a static scenario in accordance with various embodiments of the invention;

FIG. 3 is a flowchart of an illustrative process for adjusting operating speeds of slave modules in a throughput scenario in accordance with various embodiments of the invention;

FIG. 4 is a flowchart of an illustrative process for turning on or turning off one or more slave modules in accordance with various embodiments of the invention;

FIG. 5 is a flowchart of an illustrative process for turning off a particular slave module in accordance with various embodiments of the invention;

FIG. 6 is a flowchart of an illustrative process for serially turning on and turning off one or more slave modules in accordance with various embodiments of the invention; and

FIG. 7 is a flowchart of an illustrative process for turning off one or more slave modules via one or more communication channels in accordance with various embodiments of the invention.

### DETAILED DESCRIPTION OF THE DISCLOSURE

Systems and methods for power management of a system having non-volatile memory (“NVM”) are provided. One or more controllers of the system (e.g., host control circuitry, an NVM controller, and/or a translation layer) can optimally turn modules of the system on or off and/or intelligently adjust the operating speeds of modules and interfaces of the system based on the type of incoming commands and the current conditions of the system. This can result in optimal system performance and reduced system power consumption.

In some embodiments, the one or more controllers can determine appropriate operating speeds for modules and interfaces of the system. This can be determined based on the types of commands that are received and one or more bottlenecks of an execution path corresponding to each type of command.

In other embodiments, a system may have a protocol allowing the one or more controllers to transmit notifications to one or more slave modules of the system. As used herein, a “slave module” can refer to any module that a particular controller can control. These notifications can cause the slave modules to turn on at an appropriate time such that latencies are not incurred in the system. In addition, these notifications can cause the slave modules to turn off at an appropriate time to reduce overall power consumption.

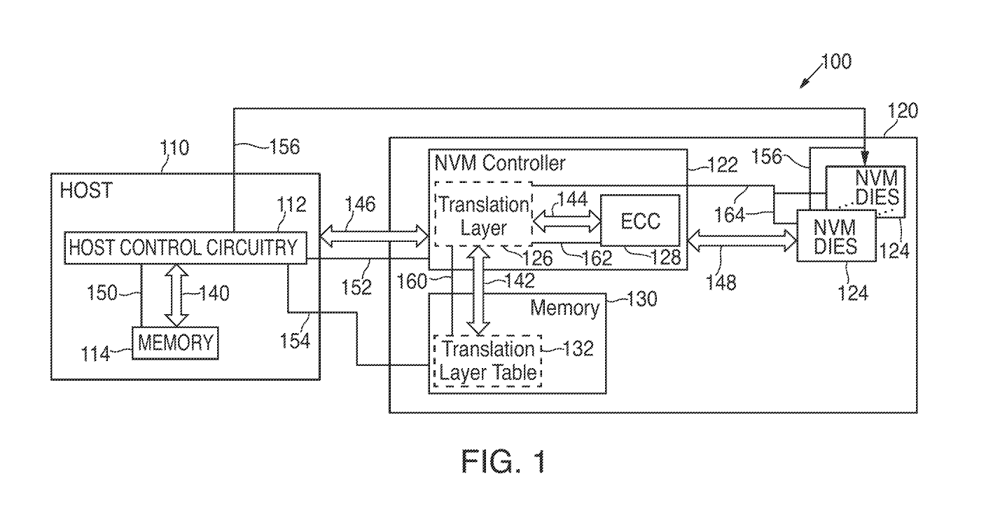

FIG. 1 illustrates a block diagram of electronic device 100. In some embodiments, electronic device 100 can be or can include a portable media player, a cellular telephone, a pocket-sized personal computer, a personal digital assistance (“PDA”), a desktop computer, a laptop computer, and any other suitable type of electronic device.

Electronic device 100 can include host 110 and non-volatile memory (“NVM”) 120. Non-volatile memory 120 can include multiple integrated circuit (“IC”) dies 124, which can be but is not limited to NAND flash memory based on floating gate or charge trapping technology, NOR flash memory, erasable programmable read only memory (“EPROM”), electrically erasable programmable read only memory (“EEPROM”), Ferroelectric RAM (“FRAM”), magnetoresistive RAM (“MRAM”), Resistive RAM (“RRAM”), semiconductor-based or non-semiconductor based non-volatile memory, or any combination thereof.

Each one of NVM dies 124 can be organized into one or more “blocks”, which can be the smallest erasable unit, and further organized into “pages”, which can be the smallest unit that can be programmed or read. Memory locations (e.g., blocks or pages of blocks) from corresponding NVM dies 124 may form “super blocks”. Each memory location (e.g., page or block) of NVM 120 can be referenced using a physical address (e.g., a physical page address or physical block address). In some cases, NVM dies 124 can be organized for random reads and writes of bytes and/or words, similar to SRAM.

NVM 120 can include NVM controller 122 that can be coupled to any suitable number of NVM dies 124. NVM controller 122 can include any suitable combination of processors, microprocessors, or hardware-based components (e.g., application-specific integrated circuits (“ASICs”)) that are configured to perform operations based on the execution of software and/or firmware instructions. NVM controller 122 can include hardware-based components, such as ASICs, that are configured to perform various operations. NVM controller 122 can perform a variety of operations such as, for example, executing access commands initiated by host 110.

NVM 120 can include memory 130, which can include any suitable type of volatile memory, such as random access memory (“RAM”) (e.g., static RAM (“SRAM”), dynamic random access memory (“DRAM”), synchronous dynamic random access memory (“SDRAM”), double-data-rate (“DDR”) RAM), cache memory, read-only memory (“ROM”), or any combination thereof. NVM controller 122 can use memory 130 to perform memory operations and/or to temporarily store data that is being read from and/or programmed to one or more NVM dies 124. For example, memory 130 can store firmware and NVM controller 122 can use the firmware to perform operations on one or more NVM dies 124 (e.g., access commands and/or memory management functions).

In some embodiments, NVM controller 122 can include translation layer 126. Translation layer 126 is shown with a dashed-line box in FIG. 1 to indicate that its function can be implemented in different locations in electronic device 100. For example, rather than being included in NVM controller 122, translation layer 126 can instead be implemented in host 110 (e.g., in host control circuitry 112).

Translation layer 126 may be or include a flash translation layer (“FTL”). Host control circuitry 112 (e.g., a file system of device 100) may operate under the control of an application or operating system running on electronic device 100, and may provide write and read requests to translation layer 126 when the application or operating system requests that information be read from or stored in one or more NVM dies 124. Along with each read or write request, host control circuitry 112 can provide a logical address to indicate where the user data should be read from or written to, such as a logical page address or a logical block address (“LBA”) with a page offset. For clarity, data that host control circuitry 112 may request for storage or retrieval may be referred to as “user data”, even though the data may not be directly associated with a user or user application. Rather, the user data can be any suitable sequence of digital information generated or obtained by host control circuitry 112 (e.g., via an application or operating system).

Upon receiving a write request, translation layer 126 can map the provided logical address to a free, erased physical location on NVM dies 124. Similarly, upon receiving a read request, translation layer 126 can use the provided logical address to determine the physical address at which the requested data is stored. Because NVM dies 124 may have a different layout depending on the size or vendor of NVM dies 124, this mapping operation may be memory and/or vendor-specific.

It will be understood that translation layer 126 can perform any other suitable functions in addition to logical-to-physical address mapping. For example, translation layer 126 can perform any of the other functions that may be typical of flash translation layers, such as garbage collection and wear leveling.

In some cases, in order to determine a physical address corresponding to a provided logical address, translation layer 126 can consult a translation layer table 132 (e.g., a FTL tables module) stored in memory 130. Like translation layer 126, translation layer table 132 is shown with a dashed-line box in FIG. 1 to indicate that its function can be implemented in different locations in electronic device 100. For example, rather than being included in memory 130, translation layer table 132 can instead be implemented in host 110 (e.g., in memory 114).

Translation layer table 132 can be any suitable data structure for providing logical-to-physical mappings between logical addresses used by host control circuitry 112 and physical addresses of NVM dies 124. In particular, translation layer table 132 can provide a mapping between LBAs and corresponding physical addresses (e.g., physical page addresses or virtual block addresses) of NVM dies 124. In some embodiments, translation layer table 132 can include one or more lookup table(s) or mapping table(s) (e.g., FTL tables). In other embodiments, translation layer table 132 can be a tree that is capable of storing the logical-to-physical mappings in a compressed form.

In some embodiments, NVM controller 122 can include error-correcting code (“ECC”) module 128. ECC module 128 can employ one or more error correcting or error detecting codes, such as a Reed-Solomon (“RS”) code, a Bose, Chaudhuri and Hocquenghem (“BCH”) code, a cyclic redundancy check (“CRC”) code, or any other suitable error correcting or detecting code. Although ECC module 128 is shown in FIG. 1 as included in NVM controller 122, persons skilled in the art will appreciate that like translation layer 126, ECC module 128 may instead be implemented in host 110 (e.g., in host control circuitry 112). By running one or more error correcting or detecting codes on user data before storing the user data in NVM dies 124, ECC module 128 can detect and/or correct errors when the user data is read from NVM dies 124.

Host 110 can include host control circuitry 112 and memory 114. Host control circuitry 112 can control the general operations and functions of host 110 and the other components of host 110 or device 100. For example, responsive to user inputs and/or the instructions of an application or operating system, host control circuitry 112 can issue read or write requests to NVM controller 122 to obtain user data from or store user data in NVM dies 124.

Host control circuitry 112 can include any combination of hardware, software, and firmware, and any components, circuitry, or logic operative to drive the functionality of electronic device 100. For example, host control circuitry 112 can include one or more processors that operate under the control of software/firmware stored in NVM 120 or memory 114.

Memory 114 can include any suitable type of volatile memory, such as random access memory (“RAM”) (e.g., static RAM (“SRAM”), dynamic random access memory (“DRAM”), synchronous dynamic random access memory (“SDRAM”), double-data-rate (“DDR”) RAM), cache memory, read-only memory (“ROM”), or any combination thereof. Memory 114 can include a data source that can temporarily store user data for programming into or reading from non-volatile memory 120. In some embodiments, memory 114 may act as the main memory for any processors implemented as part of host control circuitry 112.

In some embodiments, electronic device 100 can include a target device, such as a flash memory drive or SD card, that includes NVM 120. In these embodiments, host control circuitry 112 may act as the host controller for the target device. For example, as the host controller, host control circuitry 110 can issue read and write requests to the target device.

Components of electronic device 100 can communicate with each other over different types of interfaces and/or communication channels. In particular, one or more interfaces can allow access commands (e.g., read, program, and erase commands) and/or data associated with access commands (e.g., user data, logical addresses, and/or physical addresses) to be transmitted between components of device 100.

As shown in FIG. 1, these interfaces are denoted by the double headed arrows. For instance, host control circuitry 112 and memory 114 may be separate hardware modules (e.g., reside on separate semiconductor chips) and may use interface 140 to transmit access commands and/or associated data to one another. Likewise, NVM controller 122 and memory 130 may be separate hardware modules and may use interface 142 to transmit access commands and/or associated data to one another.

Within NVM controller 122, translation layer 126 and ECC module 128 can transmit access commands and/or associated data via ECC-translation layer interface 144. In addition, host 110 can transmit access commands and/or associated data to NVM 120 via host interface 146. Furthermore, NVM controller 122 can transmit access commands and/or associated data to NVM dies 124 via NVM bus 148.

Persons skilled in the art will appreciate that each of interfaces 140-148 can be an interface that enables communication of access commands and/or associated data between multiple components of electronic device 100. For example, each of interfaces 140-148 can be a toggle interface, a double data rate (“DDR”) interface, a Peripheral Component Interconnect Express (“PCIe”) interface, and/or a Serial Advanced Technology Attachment (“SATA”) interface.

Each of interfaces 140-148 can be pre-configured with a maximum operating speed, which can be stored in device memory (e.g., memory 112, memory 130, and/or NVM dies 124) and accessed by host control circuitry 112 or NVM controller 122. For example, host interface 146 can have a maximum operating speed of 1 GB/s. In addition, for some interfaces, maximum operating speeds can vary depending on the type of access commands being executed. For example, for a program command, NVM bus 148 can have a maximum operating speed of 20 MB/s per NVM die. In contrast, for a read command, NVM bus 148 can have a maximum operating speed of 400 MB/s per NVM die.

In addition to interfaces, electronic device 100 can have one or more communication channels that allow a controller (e.g., host control circuitry 112, NVM controller 122, or translation layer 126) to transmit notifications to one or more of its slave modules. In some cases, these notifications can allow the controller to turn on, turn off, and/or adjust the operating speeds of associated slave modules. As used herein, a “slave module” can refer to any module that a particular controller of device 100 can control.

Typically, a controller and each of its slave modules may be separate hardware modules (e.g., reside on separate semiconductor chips). For example, NVM controller 122, NVM dies 124, and memory 130 may be separate hardware modules. As another example, host control circuitry 112 and memory 114 may be separate hardware modules. Persons skilled in the art will appreciate, however, that the controller and one or more of its slave module(s) may instead reside on the same hardware module (e.g., on the same semiconductor chip).

As shown in FIG. 1, communication channels of device 100 are denoted by solid lines. For instance, channels 150-156 may couple host control circuitry 112 to its slave modules. That is, channels 150, 152, 154, and 156 can couple host control circuitry 112 to memory 114, translation layer 126, translation layer table 132, and NVM dies 124, respectively. Similarly, channels 160-164 may couple translation layer 126 to its slave modules. That is, channels 160, 162, and 164 can couple translation layer 126 to translation layer table 132, ECC module 128, and NVM dies 124, respectively. Persons skilled in the art will appreciate that device 100 can include additional communication channels that are not shown in FIG. 1. For example, separate communication channels can couple NVM controller 122 to its associated slave modules (e.g., NVM dies 124 and/or memory 130).

Persons skilled in the art will appreciate that each of communication channels 150-156 and 160-164 can be a channel that enables notifications to be transmitted between a controller and one or more of its slave modules. For example, each of channels 150-156 and 160-164 can be a toggle interface, a double data rate (“DDR”) interface, a Peripheral Component Interconnect Express (“PCIe”) interface, and/or a Serial Advanced Technology Attachment (“SATA”) interface.

The “on/off” state and operating speeds of different modules of device 100 can impact the overall power consumption of device 100. In a conventional system, modules may be kept continuously awake. For some access commands, however, only a subset of modules may be involved with executing the access command at any given time.

In addition, in conventional systems, modules and interfaces may operate at pre-configured operating speeds. Running the modules and interfaces at these pre-configured operating speeds, however, can be wasteful. In particular, for certain types of access commands, there may be bottlenecks in a particular execution path (e.g., pipeline) that limit how fast user data can be processed. As used herein, an “execution path” may include all of the interfaces and modules of a system that are involved with executing a command.

Accordingly, in a system where a host (e.g., host 110) has knowledge of the type of incoming requests (e.g., read, write, or erase requests) and the current conditions of the system, the host can intelligently make decisions regarding the trade-off between system performance and power. In particular, if the host has the ability to control one or more modules in a device (e.g., device 100), the host (and/or another component of the system) can optimally turn modules on or off and/or intelligently adjust the operating speeds of modules and interfaces of the system. This can result in optimal system performance and can reduce overall system power consumption.

For example, the power consumption (P) of a system can be provided by:

PαV̂2*C*f (1),

where V is voltage, C is capacitance, and f is frequency. Assuming that voltage and capacitance are both fixed, the following equation can be obtained for power consumption:

Pαf (2).

As shown in equation (2), power is directly proportional to frequency. Consequently, if system modules and interfaces are running at higher operating speeds (e.g., higher frequencies), more power is consumed. Likewise, if modules and interfaces are running at lower operating speeds (e.g., lower frequencies), less power is consumed.

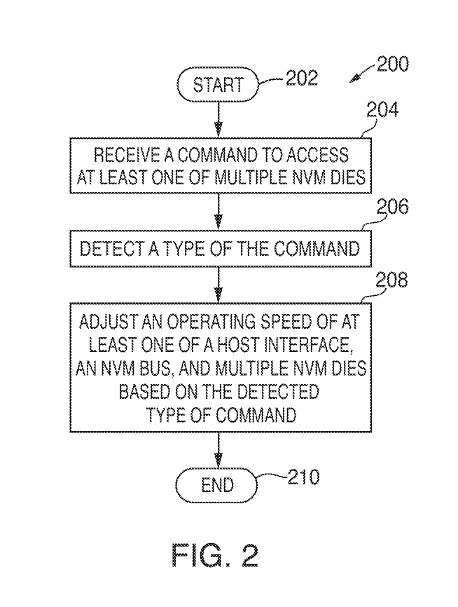

In some embodiments, based on the types of access commands that are received and the determination of one or more bottlenecks of an execution path corresponding to each type of command, the appropriate operating speeds for various modules and interfaces can be determined. For example, in static scenarios (e.g., where a single access command is received), a bottleneck of an execution path can be determined, and the operating speeds of interfaces and modules can be adjusted based on the determined bottleneck. Turning now to FIG. 2, a flowchart of illustrative process 200 is shown for adjusting operating speeds of one or more modules and interfaces of a system (e.g., electronic device 100 of FIG. 1) in a static scenario.

The system can include a host (e.g., host 110 of FIG. 1), a host interface (e.g., host interface 146 of FIG. 1), and an NVM controller (e.g., NVM controller 122 of FIG. 1) configured to communicate with the host via the host interface. In addition, the system can include an NVM bus (e.g., NVM bus 148 of FIG. 1) and multiple NVM dies (e.g., NVM dies 124 of FIG. 1) configured to communicate with the NVM controller via the NVM bus.

Process 200 may begin at step 202, and at step 204, the host (or one or more components of the host such as host control circuitry 112 of FIG. 1) and/or the NVM controller can receive a command (e.g., a read, program, or erase command) to access at least one of the multiple NVM dies.

Then, at step 206, the host and/or the NVM controller can detect a type of the command. For example, the host and/or the NVM controller can detect whether the command is a program or read command.

At step 208, the host and/or the NVM controller can adjust an operating speed of at least one of the host interface, the NVM bus, and the multiple NVM dies based on the detected type of command. For example, if the host and/or the NVM controller detects that the command is a program command, the host and/or the NVM controller can slow down the host interface until an operating speed of the host interface matches a maximum operating speed of the NVM bus. This is because the NVM bus may be the bottleneck in the execution path of the program command. In particular, as discussed previously, the NVM bus can have a maximum operating speed of 20 MB/s per NVM die, whereas the host interface can have a maximum operating speed of 1 GB/s. As a result, commands and associated user data may not need to be transmitted as quickly over the host interface to obtain the same system performance. By slowing down the host interface, system power consumption can be reduced.

If, however, the host and/or the NVM controller detects that the command is a read command, an opposite approach may be taken. For instance, because the host interface may be faster than the NVM bus, the host and/or and the NVM controller can speed up the NVM bus in order to transfer more data out of the multiple NVM dies.

Alternatively or additionally, the host and/or the NVM controller can reduce the operating speeds of at least a portion of the multiple NVM dies to match the maximum operating speed of the host interface (e.g., 1 GB/s). In particular, assuming that the NVM bus has a maximum operating speed of 400 MB/s per NVM die, only 2.5 NVM dies need to operate in order to saturate the host interface. However, because there may be more NVM dies (e.g., 32 NVM dies) in an NVM (e.g., an NVM package), the host and/or the NVM controller can run one or more of the NVM dies at a slower operating speed. This may be sufficient to saturate the host interface.

In further embodiments, the host can detect that a command is a program or read command. Upon receiving the program or read command from the host, the NVM controller (e.g., a translation layer of the NVM controller) can adjust an operating speed of at least one associated slave module (e.g., one or more NVM dies) and/or at least one associated slave interface (e.g., the NVM bus). For instance, referring back to FIG. 1, translation layer 126 can use channel 164 to slow down or speed up the operating speeds of one or more NVM dies 124. After operating speeds have been adjusted, process 200 may end at step 210.

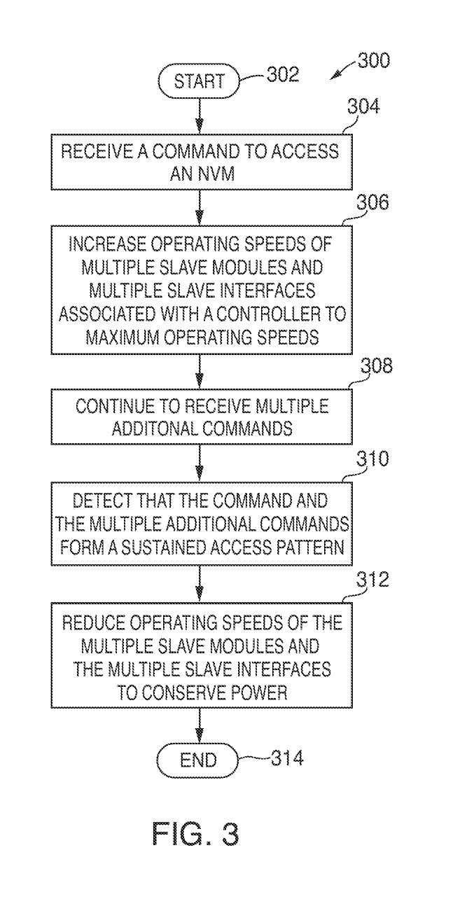

In some embodiments, particularly for throughput scenarios (e.g., where multiple access commands of the same type are received consecutively), the operating speeds of interfaces and modules can be first increased and then decreased. Turning now to FIG. 3, a flowchart of illustrative process 300 is shown for adjusting operating speeds of slave modules of a system (e.g., electronic device 100 of FIG. 1) in a throughput scenario. The system can include a host (e.g., host 110 of FIG. 1) and an NVM (e.g., NVM 120 of FIG. 1) coupled to the host.

Process 300 may begin at step 302, and at step 304, a controller (e.g., host control circuitry 112 of FIG. 1, NVM controller 122 of FIG. 1, and/or translation layer 126 of FIG. 1) can receive a command (e.g., a read, program, or erase command) to access the NVM. For example, the command can be a 4 KB read command or a 4 KB program command.

Then, at step 306, the controller can increase operating speeds of multiple slave modules (e.g., memory 114 of FIG. 1, translation layer 126 of FIG. 1, memory 130 of FIG. 1, NVM dies 124 of FIG. 1, and ECC module 128 of FIG. 1) and multiple slave interfaces (e.g., interfaces 140-148 of FIG. 1) associated with the controller to maximum operating speeds. This is because latency is a concern for an initial read or program command. Although increasing the operating speeds (e.g., frequencies) at which slave modules and slave interfaces are driven increases power consumption, the associated latencies can be reduced.

For example, for a read command, increasing the operating speeds reduces the time that it takes for an application or operating system to receive user data from the NVM. Likewise, for a program command, increasing the operating speeds reduces the time that an application or operating system needs to wait for associated user data to be programmed on the NVM.

Continuing to step 308, the controller can continue to receive multiple additional commands. At step 310, the controller can detect that the command and the multiple additional commands form a sustained access pattern. For example, if the command is a read command and the multiple additional commands are also read commands, the controller can determine that there is a sustained read pattern. As another example, if the command is a program command and the multiple additional program commands are also program commands, the controller can determine that there is a sustained write pattern.

Then, at step 312, the controller can reduce operating speeds of the multiple slave modules and the multiple slave interfaces to conserve power. For example, the controller can detect a slowest interface of the multiple slave interfaces. After detecting the slowest interface, the controller can slow down the remaining slave interfaces such that the slowest interface is saturated. For instance, the NVM bus (e.g., NVM bus 148 of FIG. 1) may be the slowest interface in an execution path. By reducing the operating speeds (e.g., frequencies) at which the remaining slave interfaces are driven, power consumption can be reduced. Process 300 may end at step 314.

Thus, by first increasing the operating speeds of slave interfaces and slave modules and then reducing the operating speeds of the slave interfaces and the slave modules in a throughput scenario, the system can make intelligent decisions regarding performance versus power. That is, when system performance is particularly important (e.g., for an initial read or program command), the system can increase operating speeds to produce optimal performance. In contrast, when power conservation is particularly important (e.g., during a sustained read or a sustained write), the system can decrease operating speeds to reduce power consumption.

The operating speeds of slave modules and slave interfaces can be adjusted in any suitable manner. For example, a controller (e.g., host control circuitry 112 of FIG. 1, NVM controller 122 of FIG. 1, or translation layer 126 of FIG. 1) can adjust a drive setting associated with each slave module/interface. Depending on the type of module or interface, adjustment of the drive setting can allow the operating speeds to change continuously or in steps.

In further embodiments, a system may have a protocol allowing a controller (e.g., host control circuitry 112 of FIG. 1, NVM controller 122 of FIG. 1, or translation layer 126 of FIG. 1) to transmit notifications to one or more slave modules of the system. For example, these notifications can cause the slave modules to turn on (e.g., enter a wake state) at an appropriate time such that latencies are not incurred in the system. Alternatively, these notifications can cause the slave modules to turn off (e.g., enter a sleep state) at an appropriate time to reduce overall power consumption.

In some cases, each module (e.g., slave module) of the system can be or can include a power island. When a power island is turned off, the inactive module(s) of the power island completely powers off and no longer consumes any static current (e.g., leakage can be eliminated). This reduces the overall power consumption of the system.

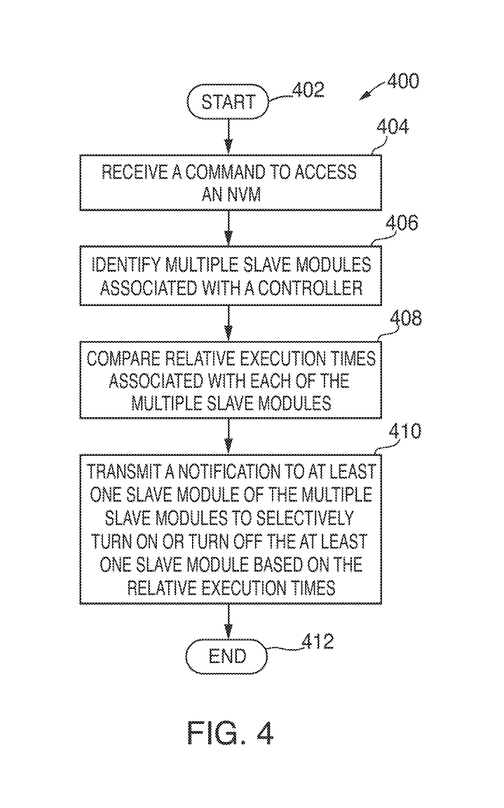

Referring now to FIG. 4, a flowchart of illustrative process 400 is shown for turning on or turning off one or more slave modules of a system (e.g., electronic device 100 of FIG. 1). Process 400 may begin at step 402, and at step 404, a controller (e.g., host control circuitry 112 of FIG. 1, NVM controller 122 of FIG. 1, and/or translation layer 126 of FIG. 1) can receive a command (e.g., a read, program, or erase command) to access an NVM (e.g., NVM 120 of FIG. 1 or NVM dies 124 of FIG. 1).

At step 406, the controller can identify multiple associated slave modules. For example, if the controller is host control circuitry, the multiple slave modules can include volatile memory of a host (e.g., memory 114 of FIG. 1), a translation layer (e.g., translation layer 126 of FIG. 1), a translation layer table (e.g., translation layer table 132 of FIG. 1), and multiple NVM dies (e.g., NVM dies 124 of FIG. 1). As another example, if the controller is the translation layer, the multiple slave modules can include an ECC module (e.g., ECC module 128 of FIG. 1), the translation layer table, and the multiple NVM dies.

In some embodiments, the controller can identify associated slave modules based on an execution path corresponding to the access command. For example, if ECC is not being applied to the user data associated with the access command (e.g., an erase command), the translation layer can bypass the ECC module in the identification of associated slave modules.

Continuing to step 408, the controller can compare relative execution times associated with each of the multiple slave modules. Then, at step 410, the controller can transmit a notification to at least one slave module of the multiple slave modules to selectively turn on or turn off the at least one slave module based on the relative execution times.

The notification can be transmitted via one of the multiple communication paths of the system. For example, for the host control circuitry, the notification can be transmitted via channels 150-156 to one or more of its slave modules. As another example, for the translation layer, the notification can be transmitted via channels 160-164 to one or more of its slave modules. In some embodiments, the notification to turn off the at least one slave module can cause the power island associated with the at least one slave module to turn off. After transmitting the notification, process 400 may end at step 412.

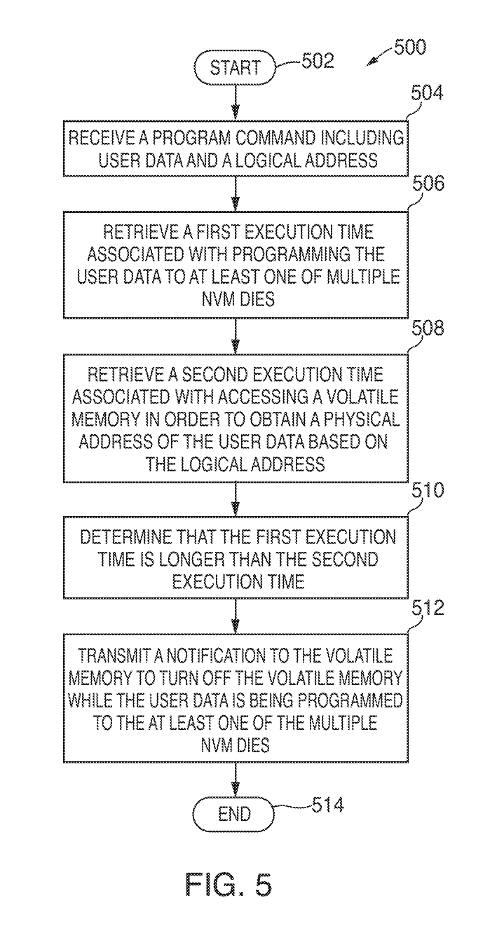

FIG. 5 shows a flowchart of illustrative process 500 for turning off a particular slave module. Process 500 may begin at step 502, and at step 504, a controller (e.g., host control circuitry 112 of FIG. 1, NVM controller 122 of FIG. 1, and/or translation layer 126 of FIG. 1) can receive a program command that includes user data and a logical address.

At step 506, the controller can retrieve a first execution time associated with programming the user data to at least one of multiple NVM dies (e.g., NVM dies 124 of FIG. 1). The controller can retrieve the first execution time from a volatile memory of the host (e.g., memory 114 of FIG. 1), a volatile memory of the NVM (e.g., memory 130 of FIG. 1), or multiple NVM dies (e.g., NVM dies 124 of FIG. 1). For example, the controller may determine that the first execution time is 1.6 milliseconds.

Continuing to step 508, the controller can retrieve a second execution time associated with accessing a volatile memory (e.g., memory 130 of FIG. 1) in order to obtain a physical address of the user data based on the logical address.

Then, at step 510, the controller can determine that the first execution time is longer than the second execution time. For example, because the volatile memory may be a buffer, the lookup time for a logical-to-physical address mapping in a translation layer table of the volatile memory can be relatively short compared to the first execution time.

At step 512, the controller can transmit a notification to the volatile memory (e.g., via channel 154 or channel 160 of FIG. 1) to turn off the volatile memory while the user data is being programmed to the at least one of the multiple NVM dies. That is, once the logical-to-physical address mapping has been obtained from the volatile memory and user data and associated physical address have been transmitted to one or more of the NVM dies, the volatile memory can be turned off. Process 500 may then end at step 514.

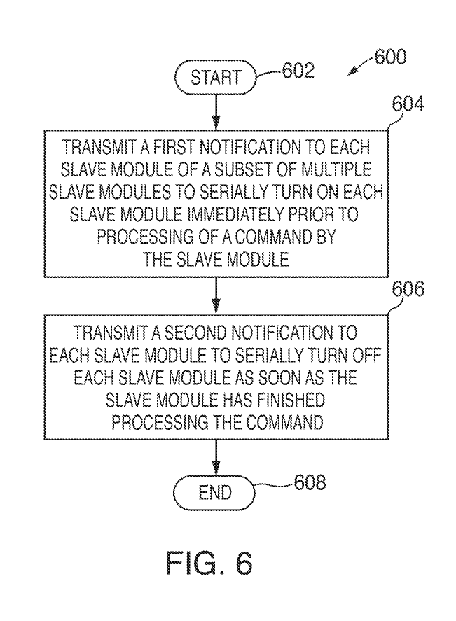

In some embodiments, in order to reduce power consumption, a subset of slave modules of a system may be in default off states. Referring next to FIG. 6, a flowchart of illustrative process 600 is shown for serially turning on and turning off one or more slave modules in such a system.

Process 600 may begin at step 602, and at step 604, a controller (e.g., host control circuitry 112 of FIG. 1, NVM controller 122 of FIG. 1, and/or translation layer 126 of FIG. 1) can transmit a first notification to each slave module of a subset of multiple slave modules to serially turn on each slave module immediately prior to processing of a command by the slave module. Because the slave modules of the subset are not all turned on at once but rather are turned on only when needed, the overall peak power of the system can be reduced.

In addition, by turning on a slave module only when it is necessary, both power consumption and latencies can be reduced. For example, by delaying the turning on of a slave module, the slave module does not consume power unnecessarily when it is not processing any commands. Furthermore, by turning on a slave module just before a command arrives at the module, latencies are not incurred because the system does not have to wait for the slave module to wake up.

Continuing to step 606, the controller can transmit a second notification to each slave module to serially turn off each slave module as soon as the slave module has finished processing the command. Thus, if a slave module is no longer needed, the slave module can be turned off to reduce power consumption. For example, once a logical-to-physical address mapping has been obtained from a translation layer table for a last piece of incoming user data, the translation layer table (and associated volatile memory) can be turned off. Process 600 may end at step 608.

As discussed previously, host control circuitry (e.g., host control circuitry 112 of FIG. 1) can be coupled to its slave modules via one or more communication channels (e.g., channels 150-156 of FIG. 1). In some embodiments, if the host control circuitry determines that the system will be in an idle mode for longer than a pre-determined amount of time, the host control circuitry can turn off at least a subset of its slave modules to reduce power consumption.

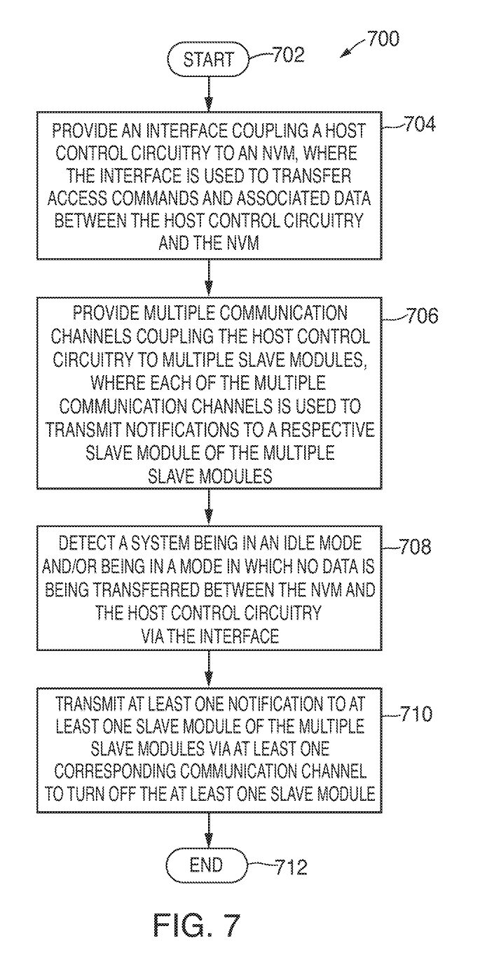

Turning to FIG. 7, a flowchart of illustrative process 700 is shown for turning off one or more slave modules via one or more communication channels of a system (e.g., electronic device 100 of FIG. 1). Process 700 may begin at step 702, and at step 704, an interface (e.g., interface 146 of FIG. 1) can be provided that couples a host control circuitry (e.g., host control circuitry 112 of FIG. 1) to an NVM (e.g., NVM 120 of FIG. 1), where the interface is used to transfer access commands (e.g., read, program, or erase commands) and associated data between the host control circuitry and the NVM.

Then, at step 706, multiple communication channels (e.g., channels 150-156) can be provided that couples the host control circuitry to multiple slave modules (e.g., memory 114 of FIG. 1, translation layer 126 of FIG. 1, translation layer table 132 of FIG. 1, and NVM dies 124 of FIG. 1), where each of the multiple communication channels is used to transmit notifications to a respective slave module of the multiple slave modules.

Continuing to step 708, the host control circuitry can detect that the system is in an idle mode and/or is in a mode in which no data is being transferred between the NVM and the host control circuitry via the interface.

Then, at step 710, the host control circuitry can transmit at least one notification to at least one slave module of the multiple slave modules via at least one corresponding communication channel to turn off the at least one slave module. For example, the host control circuitry can transmit notifications to the translation layer table, the NVM dies, and its own volatile memory. However, the host control circuitry may not transmit any notifications to the translation layer because the translation layer may need to remain powered on in order to receive future commands and/or notifications from the host control circuitry. Process 700 may end at step 712.

In some embodiments, the translation layer can have control over its own slave modules (e.g., ECC module 128 of FIG. 1, translation layer table 132 of FIG. 1, and NVM dies 124 of FIG. 1). By having control over these slave modules, the translation layer can assist the host in power regulating different modules of the system. For example, in response to receiving an erase command from the host, the translation layer can determine that ECC does not need to be performed on the erase command. Consequently, the translation layer can transmit a notification (e.g., via channel 162 of FIG. 1) to an ECC module (e.g., ECC module 128 of FIG. 1) to turn off the ECC module. Alternatively, if the ECC module is in a default off state, the translation layer can select not to transmit a notification to the ECC module to turn on the ECC module.

It should be understood that processes 200-700 of FIGS. 2-7 are merely illustrative. Any of the steps may be removed, modified, or combined, and any additional steps may be added, without departing from the scope of the invention.

The described embodiments of the invention are presented for the purpose of illustration and not of limitation.

What is claimed is:

1. A system comprising:
a host;
a host interface;
a non-volatile memory (“NVM”) controller operative to communicate with the host via the host interface;
an NVM bus; and
a plurality of NVM dies operative to communicate with the NVM controller via the NVM bus, wherein at least one of the host and the NVM controller is operative to:
receive a command to access at least one of the plurality of NVM dies;
detect a type of the command; and
adjust an operating speed of at least one of the host interface, the NVM bus, and the plurality of NVM dies based on the detected type of command.

2. The system of claim 1, wherein at least one of the host and the NVM controller is operative to adjust drive settings in order to adjust the operating speed of the at least one of the host interface, the NVM bus, and the plurality of the NVM dies.

3. The system of claim 1, wherein the host interface and the NVM bus is one of a toggle interface, a double data rate (“DDR”) interface, a Peripheral Component Interconnect Express (“PCIe”) interface, and a Serial Advanced Technology Attachment (“SATA”) interface.

4. The system of claim 1, wherein the host is operative to detect that the command is one of a program command and a read command, and wherein the NVM controller is operative to adjust an operating speed of at least one slave module and at least one slave interface.

5. The system of claim 4, wherein the at least one slave module comprises at least one of the plurality of NVM dies.

6. The system of claim 4, wherein the at least one slave interface comprises the NVM bus.

7. The system of claim 1, wherein the at least one of the host and the NVM controller is operative to:
detect that the command is a program command; and
slow down the host interface until an operating speed of the host interface matches a maximum operating speed of the NVM bus.

8. The system of claim 1, wherein the at least one of the host and the NVM controller is operative to:
detect that the command is a read command; and
speed up the NVM bus to transfer more data out of the plurality of NVM dies.

9. The system of claim 1, wherein the at least one of the host and the NVM controller is operative to:
detect that the command is a read command; and
reduce operating speeds of at least a portion of the plurality of NVM dies to match a maximum operating speed of the host interface.

10. A controller of a system having a non-volatile memory (“NVM”), wherein the controller is operative to:
receive a command to access the NVM;
identify a plurality of slave modules associated with the controller;
compare relative execution times associated with each of the plurality of slave modules; and
transmit a notification to at least one slave module of the plurality of slave modules to selectively turn on and turn off the at least one slave module based on the relative execution times.

11. The controller of claim 10, wherein the controller is at least one of a host control circuitry of a host coupled to the NVM and an NVM controller of the NVM.

12. The controller of claim 11, wherein the plurality of slave modules associated with the host control circuitry comprises a volatile memory of the host, a flash translation layer (“FTL”) of the NVM, a FTL tables module of the NVM, and a plurality of NVM dies of the NVM.

13. The controller of claim 11, wherein the NVM controller comprises a flash translation layer (“FTL”).

14. The controller of claim 13, wherein the plurality of slave modules associated with the FTL comprises an error-correcting code (“ECC”) module of the NVM, a FTL tables module of the NVM, and a plurality of NVM dies of the NVM.

15. The controller of claim 10, wherein each slave module of the plurality of slave modules comprises a power island such that when the power island is turned off, the slave module no longer consumes static current.

16. The controller of claim 11, wherein the notification to turn off the at leave one slave module causes the power island associated with the at least one slave module to turn off.

17. The controller of claim 10, wherein the NVM comprises a plurality of NVM dies, and wherein the controller is further operative to:
receive a program command comprising user data and a logical address;
retrieve a first execution time associated with programming the user data to at least one of the plurality of NVM dies;
retrieve a second execution time associated with accessing a volatile memory of the system in order to obtain a physical address of the user data based on the logical address;
determine that the first execution time is longer than the second execution time; and
transmit the notification to the volatile memory to turn off the volatile memory while the user data is being programmed to the at least one of the plurality of NVM dies.

18. The controller of claim 10, wherein a subset of the plurality of slave modules are in off states, and the controller is further operative to:
transmit a first notification to each slave module of the subset of the plurality of slave modules to serially turn on each slave module immediately prior to processing of the command by the slave module; and
transmit a second notification to each slave module to serially turn off each slave module as soon as the slave module has finished processing the command.

19. A system comprising:
a host;
a non-volatile memory (“NVM”) operative to be coupled to the host; and
a controller operative to:
receive a command to access the NVM;
increase operating speeds of a plurality of slave modules and a plurality of slave interfaces associated with the controller to maximum operating speeds;
continue to receive a plurality of additional commands;
detect that the command and the plurality of additional commands form a sustained access pattern; and
reduce operating speeds of the plurality of slave modules and the plurality of slave interfaces to conserve power.

20. The system of claim 19, wherein the controller is further operative to:
detect a slowest interface of the plurality of slave interfaces; and
slow down the remaining slave interfaces of the plurality of slave interfaces such that the slowest interface is saturated.

21. The system of claim 19, wherein the command is one of a 4 KB read command and a 4K program command.

22. The system of claim 19, wherein the sustained access pattern is one of a sustained read pattern and a sustained write pattern.

23. The system of claim 19, wherein the controller is at least one of a host control circuitry and an NVM controller.

24. The system of claim 23, wherein the NVM controller comprises a flash translation layer (“FTL”).

25. The system of claim 19, wherein the plurality of slave modules comprises a dynamic random-access memory (“DRAM”) of the host, a FTL of the NVM, a DRAM of the NVM, a plurality of NVM dies of the NVM, and an error-correcting code (“ECC”) module of the NVM.

26. A method for optimizing power in a system comprising a non-volatile memory (“NVM”) and a host, the method comprising:
providing an interface coupling a host control circuitry of the host to the NVM, wherein the interface is used to transfer access commands and associated data between the host control circuitry and the NVM;
providing a plurality of communication channels coupling the host control circuitry to a plurality of slave modules, wherein each of the plurality of communication channels is used to transmit notifications to a respective slave module of the plurality of slave modules;
detecting at least one of the system being in an idle mode and the system being in a mode in which no data is being transferred between the NVM and the host control circuitry via the interface; and
transmitting at least one notification to at least one slave module of the plurality of slave modules via at least one corresponding communication channel to turn off the at least one slave module.

27. The method of claim 26, wherein the NVM comprises a plurality of NVM dies, a flash translation layer (“FTL”), and a FTL tables module.

28. The method of claim 27, wherein the plurality of slave modules comprises the FTL, the FTL tables module, the plurality of NVM dies, and volatile memory of the host.

29. The method of claim 28, further comprising transmitting the at least one notification only to the FTL tables module, the plurality of NVM dies, and the volatile memory.

30. The method of claim 26, further comprising:
receiving an erase command; and
transmitting a notification to an error-correcting code (“ECC”) module to turn off the ECC module.
